(19) United States
(12) Patent Application Publication
(10) Pub. No.: US 2007/0009169 A1
(43) Pub. Date: Jan. 11, 2007

(54) Constrained image deblurring for imaging devices with motion sensing

(76) Inventor: Anoop K. Bhattacharjya, Campbell, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/177,804

(22) Filed: Jul. 8, 2005

(51) Int. Cl. G06K 9/40

(52) U.S. Cl. 382/255

(57) ABSTRACT

Systems and methods are disclosed for deblurring a captured image using parametric deconvolution, instead of a blind, non-parametric deconvolution, by incorporating physical constraints derived from sensor inputs, such as a motion sensor, into the deconvolution process to constrain modifications to the point spread function. In an embodiment, a captured image is deblurred using a point spread function obtained from the cross-validation of information across a plurality of image blocks taken from the capture image, which image blocks are deconvolved using parametric deconvolution to constrain modifications to the point spread function.

### BACKGROUND

1. Field of the Invention

The present invention relates generally to the field of imaging processing, and more particularly to systems and methods for correcting blurring introduced into a captured image by motion of the imaging device while capturing the image.

2. Background of the Invention

A digital camera captures an image by integrating the energy focused on a semiconductor device over a period of time, referred to as the exposure time. If the camera is moved during the exposure time, the captured image may be blurred. Several factors can contribute to camera motion. Despite a person's best efforts, slight involuntary movements while taking a picture may result in a blurred image. The camera's size may make it difficult to stabilize the camera. Pressing the camera's shutter button may also cause jitter.

Blurring is also prevalent when taking pictures with long exposure times. For example, photographing in low light environments typically requires long exposure times to acquire images of acceptable quality. As the amount of exposure time increases, the risk of blurring also increases because the camera must remain stationary for a longer period of time.

In certain cases, camera motion can be reduced, or even eliminated. A camera may be stabilized by placing it on a tripod or stand. Using a flash in low light environments can help reduce the exposure time. Some expensive devices attempt to compensate for camera motion problems by incorporating complex adaptive optics into the camera that respond to signals from sensors.

Although these various remedies are helpful in reducing or eliminating blurring, they have limits. It is not always feasible or practical to use a tripod or stand. And, in some situations, such as taking a picture from a moving platform like a ferry, car, or train, using a tripod or stand may not sufficiently ameliorate the problem. A flash is only useful when the distance between the camera and the object to be imaged is relatively small. The complex and expensive components needed for adaptive optics solutions are too costly for use in all digital cameras, particularly low-end cameras.

Since camera motion and the resulting image blur cannot always be eliminated, other solutions have focused on attempting to remove the blur from the captured image. Post-imaging processing techniques to deblur images have included using sharpening and deconvolution algorithms. Although successful to some degree, these algorithms are also deficient.

Consider, for example, the blind deconvolution algorithm. The blind deconvolution attempts to extract the true, unblurred image from the blurred image. In its simplest form, the blurred image may be modeled as the true image convolved with a blurring function, typically referred to as a point spread function (“psf”). The blurring function represents, at least in part, the camera motion during the exposure interval. Blind deconvolution is “blind” because there is no knowledge concerning either the true image or the point spread function. The true image and blurring function are guessed and then convolved together. The resulting image is then compared with the actual blurred image. A correction is computed based upon the comparison, and this correction is used to generate a new estimate of the true image, the blurring function, or both. The process is iterated with the hopes that the true image will emerge. Since two variables, the true image and the blurring function, are initially guessed and iteratively changed, it is possible that the blind convolution method might not converge on a solution, or it might converge on a solution that does not yield the true image.

Accordingly, what is needed are systems and methods that produce better representations of a true, unblurred image given a blurred captured image.

### SUMMARY OF THE INVENTION

According to an aspect of the present invention, systems and methods are disclosed for deblurring a captured image. In an embodiment, a blurred captured image taken with an imaging device that includes at least one motion sensor may be deblurred by obtaining a set of parameters, including motion parameters from the motion sensor that relate to the motion of the imaging sensor array during the exposure time. At least one of the parameters may include an associated interval value or values, such as, for example, a measurement tolerance, such that a family of motion paths may be defined that represents the possible motion paths taken during the exposure time. An estimated point spread function that represents the convolution of an optical point spread function of the imaging device and a motion path selected from the family of motion paths is obtained. Having selected an estimated deblurred image, a new estimated point spread function can be calculated based upon the captured image, the estimated deblurred image, and the estimated point spread function. An optimization over the set of motion parameters and associated interval values is performed to find a set of optimized parameter values within the set of motion parameters and associated interval values that yields an optimized point spread function that best fits the new estimated point spread function. By optimizing over the set of motion parameters and associated interval values, the point spread function is constrained to be within the family of possible motion paths. The optimized point spread function may then be used to compute a new estimated deblurred image. This process may be repeated a set number of times or until the image converses.

According to another aspect of the present invention, a captured image may represent portions, or image blocks, of a larger captured image. In one embodiment, a captured image may be deblurred by selecting two or more image blocks from the captured image. A point spread function is estimated within each of the image blocks, wherein each point spread function is consistent with a set of motion parameter values taken by the motion sensor during the capturing of the captured image. A deconvolution algorithm is employed to deblur each of the image blocks and wherein a modification to any of the point spread functions of the image blocks is consistent with the set of motion parameter values taken by the motion sensor during the exposure time. In an embodiment, cross-validation of information across the plurality of image blocks may be used to select a best point spread function from the point spread functions of the image blocks, and the captured image may be deblurred using this point spread function.

Although the features and advantages of the invention are generally described in this summary section and the following detailed description section in the context of embodiments, it shall be understood that the scope of the invention should not be limited to these particular embodiments. Many additional features and advantages will be apparent to one of ordinary skill in the art in view of the drawings, specification, and claims hereof.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

Figure (“FIG.”) 1 depicts an imaging device according to an embodiment of the present invention.

FIG. 2 depicts a method for deblurring a blurred captured image according to an embodiment of the present invention.

FIG. 3 illustrates a method, according to an embodiment of the present invention, for constructing a point spread function that represents the blur caused by both the motion of the imaging device and the optical blur of the imaging device.

FIG. 4 illustrates an exemplary motion path according to an embodiment of the present invention.

FIG. 5 graphically depicts the joint point spread function from a feature motion path and an optical point spread function according to an embodiment of the present invention.

FIG. 6 graphically depicts image blocks with their corresponding regions of support within a captured image according to an embodiment of the present invention.

FIG. 7 illustrates a method for deblurring a blurred captured image according to an embodiment of the present invention.

FIG. 8A graphically illustrates a set or family of feature motion paths based upon the measured motion parameters according to an embodiment of the present invention.

FIG. 8B graphically illustrates an exemplary estimated feature motion path that may result from the deconvolution process wherein some portion or portions of the estimated feature motion path fall outside the family of feature motion paths which have been based upon the measured motion parameters according to an embodiment of the present invention.

FIG. 8C graphically illustrates an exemplary estimated feature motion path that has been modifying according to an embodiment of the present invention to keep the estimated motion path within the family of feature motion paths which have been based upon the measured motion parameters.

### DETAILED DESCRIPTION OF THE INVENTION

In the following description, for purposes of explanation, specific details are set forth in order to provide an understanding of the invention. It will be apparent, however, to one skilled in the art that the invention can be practiced without these details. One skilled in the art will recognize that embodiments of the present invention, described below, may be performed in a variety of ways and using a variety of means. Those skilled in the art will also recognize additional modifications, applications, and embodiments are within the scope thereof, as are additional fields in which the invention may provide utility. Accordingly, the embodiments described below are illustrative of specific embodiments of the invention and are meant to avoid obscuring the invention.

Reference in the specification to “one embodiment” or “an embodiment” means that a particular feature, structure, characteristic, or function described in connection with the embodiment is included in at least one embodiment of the invention. Furthermore, the appearance of the phrase “in one embodiment,” “in an embodiment,” or the like in various places in the specification are not necessarily all referring to the same embodiment.

FIG. 1 depicts a digital imaging device 100 according to an embodiment of the present invention. Imaging device 100 is comprised of a lens 101 for focusing an image onto an image sensor array 102. Image sensor array 102 may be a semiconductor device, such as a charge coupled device (CCD) sensor array or complementary metal oxide semiconductor (CMOS) sensor array. Image sensor array 102 is communicatively coupled to a processor or application specific integrated circuit for processing the image captured by image sensor array 102. In an embodiment, imaging device 100 may also possess permanent or removable memory 104 for use by processor 103 to store data temporarily, permanently, or both.

Also communicatively coupled to processor 103 is motion sensor 105. Motion sensor 105 provides to processor 103 the motion information during the exposure time. As will be discussed in more detail below, the motion information from motion sensor 105 is used to constrain point spread function estimates during the deblurring process.

Motion sensor 105 may comprise one or more motion sensing devices, such as gyroscopes, accelerometers, magnetic sensors, and other motion sensors. In an embodiment, motion sensor 105 comprises more than one motion sensing device. In an alternate embodiment, motion sensing devices of motion sensor 105 may be located at different locations within or on imaging device 100. The advent of accurate, compact, and inexpensive motion sensors and gyroscopes currently make it feasible to include such devices in imaging devices, even low-cost digital cameras.

Imaging device 100 is presented to elucidate the present invention; for that reason, it should be noted that no particular imaging device or imaging device configuration is critical to the practice of the present invention. Indeed, one skilled in the art will recognize that any digital imaging device, or a non-digital imaging device in which the captured image has been digitized, equipped with a motion sensor or sensors may practice the present invention. Furthermore, the present invention may be utilized with any device that incorporates a digital imaging device, including, but not limited to, digital cameras, video cameras, mobile phones, personal data assistants (PDAs), web cameras, computers, and the like.

Consider, for the purposes of illustration and without loss of generality, the case of an image with a single color channel. A captured image, such as one obtained by imaging device 100, may be denoted as g(x,y). For the purposes of illustration, the ideal, deblurred image is denoted as f(x,y). The captured image, g(x,y), may be related to the desired image, f(x,y), by accumulating the results of first warping f by the motion of the sensor followed by convolution with the optical point spread function, followed by the addition of noise arising from electronic, photoelectric, and quantization effects. Specifically,
g(x,y)=f(x,y)*h(x,y)+n(x,y) (1)

where, h(x,y) denotes a point spread function representing the effect of combining the imaging device motion and the imaging device optics, “*” denotes the convolution operator, and n(x,y) is the additive noise.

In an embodiment, image sensor array 102 of imaging device 100 samples a window of an image to be captured, and this window moves as imaging device 100 moves. All motion information obtained from motion sensor 105 is assumed to be relative to the position and orientation of this window at the time the shutter was opened. Since the image objects are assumed to be at a distance that is many times the camera focal length, the motion may be considered to be compositions of translations in the plane of image sensor array 102, and small rotations between successive motion measurements around an unknown center of rotation, depending on how imaging device 100 is being held by the user.

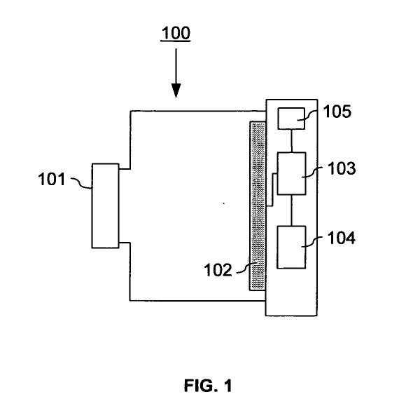

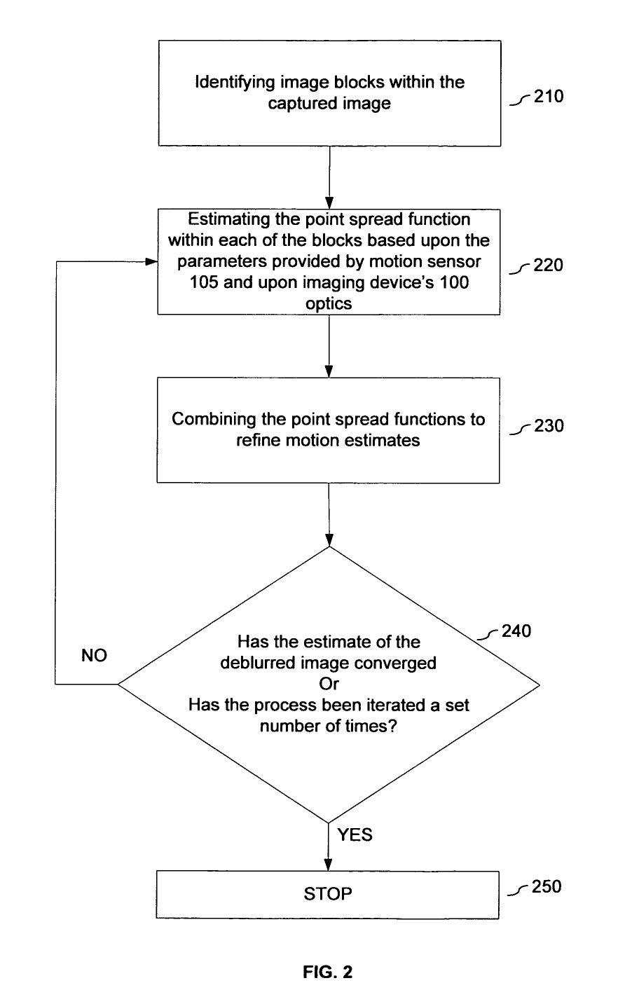

FIG. 2 depicts a method for obtaining a deblurred image from a blurred captured image according to an embodiment of the present invention. In the depicted embodiment, the method begins by identifying 210 image blocks within the captured imaged. In an embodiment, an image block may be the entire captured image. In an alternate embodiment, a plurality of image blocks may be selected from the same captured imaged. Image blocks may be chosen to contain image regions with high contrast and image variation, or image regions with high contrast and “point-like” features, such as, for example the image of a streetlight taken from a distance on a clear night. The use of image blocks internal to the blurred image circumvents some of the boundary problems associated with estimating the point spread function from the entire image. Within each of the image blocks, the point spread function is estimated 220 based upon the parameters provided by motion sensor 105 and upon the imaging device's optics. This step uses parametric optimization, using measurements from motion sensor 105 as parameters, instead of a blind, non-parametric approach, to allow incorporation of physical constraints to better constrain the point spread function estimates. The point spread functions from each of the image blocks are combined 230 to refine the motion estimates. In an embodiment, the point spread functions from each of the image blocks may be combined to also refine the estimate of the center of rotation.

It should be noted that estimating the point spread function over smaller image blocks rather than over the entire image leads to further simplification because the contribution of motion due to rotation within each image block may be modeled effectively as translations that are the same for each pixel within the block, although they may be different across blocks. This simplification is reasonable as in typical handheld device, for example, cameras, mobile phones, and the like, wherein the center of rotation generally may be located a distance away from the motion sensor. It may also be assumed that the angles of rotation are small.

Returning to FIG. 2, the process of estimating the point spread function and comparing them across the image blocks is repeated 240 until the estimate of the deblurred image converges 250, or until the process has been iterated a set number of times 250. Each of the foregoing steps of FIG. 2 will be explained in more detail below.

1. Parameters

In an embodiment, parameters which may be used in the present invention to help define or constrain the point spread function may be represented by the tuple:
{sₓ(tᵢ),s_{y}(tᵢ),s_{θ}(tᵢ),r(tᵢ),α,tᵢ} (2)

where, tᵢ denotes time since the opening of the shutter, sₓ(tᵢ) and s_{y}(tᵢ) are the translation inputs from motion sensor 105, s_{θ}(tᵢ) is the rotation input from motion sensor 105, r(tᵢ) is the unknown center of rotation with respect to a position of the image (for example, the lower left corner of the image), and α is an unknown constant that maps motion measurements to pixel space. If the image sensor array pixels are not square, two parameters, αₓ and α_{y}, may be used instead of a single α parameter. In an embodiment, values of r(tᵢ) and α are known based on device geometry and prior calibration. In an alternate embodiment, values of r(tᵢ) and α are estimated in the course of computation. These values may be estimated by adding them as unknowns in the set of parameters to be estimated. At each optimization step, which will be explained in more detail below, a search may be conducted over these variables to select the best estimate that is consistent with the measurements. Typically, there are good constraints available on the range of possible values for r(tᵢ) and α. One skilled skilled in the art will be recognized this method as an instance of the “Expectation Maximization” algorithm.

In an embodiment, variables in the parameter tuple are sampled sufficiently frequently and the motion is assumed to be sufficiently smooth so that a smooth interpolation of the measurements would represent the continuous evolution of these variables. In one embodiment, the parameters are sampled at least twice the maximum frequency of motion.

In an embodiment, noisy measurements may be used to estimate the parameters using well-known procedures, such as Kalman filtering. In an alternate embodiment, tolerances may be specified for each measurement, and these tolerances may be formulated as constraints used to refine the measurements while doing iterative point spread function estimation as presented in more detail below.

In an embodiment, the optical point spread function related to the imaging device's 100 optics is assumed to be constant and may be estimated by registering and averaging several images of a point source, such as an illuminated pin hole.

2. Constructing the Combined Motion and Optical Point Spread Function

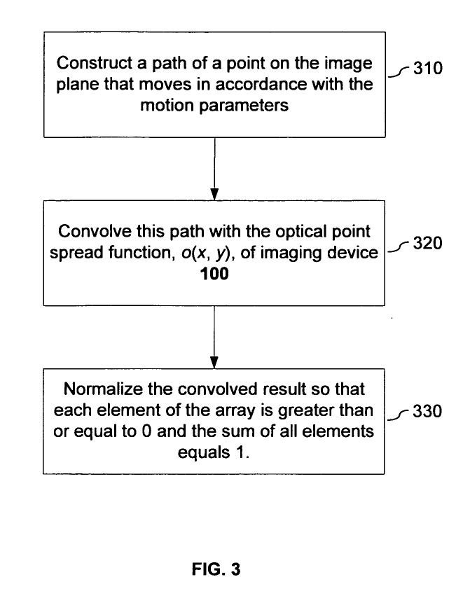

FIG. 3 depict a method for constructing a combined point spread function according to an embodiment of the present invention. The point spread function representing both the motion and optical blur may be constructed by constructing 310 the path of a point on the image plane that moves in accordance with the motion parameters specified in the tuple (2), above. The path (x(t),y(t)) traced out by an image point starting at location (x(0), y(0)) is given by:

$$[ \begin{matrix}x ( t ) \\ y ( t )\end{matrix} ] = {R}_{- {s}_{θ} ( t )} ( [ \begin{matrix}x ( 0 ) \\ y ( 0 )\end{matrix} ] + [ \begin{matrix}{α}_{x} & 0 \\ 0 & {α}_{y}\end{matrix} ] ( r ( t ) - r ( 0 ) - [ \begin{matrix}{s}_{x} ( t ) \\ {s}_{y} ( t )\end{matrix} ] ) ) \qquad ( 3 )$$

where, R_{θ} denotes the rotation matrix,

$${R}_{θ} = [ \begin{matrix}cos ( θ ) & - sin ( θ ) \\ sin ( θ ) & cos ( θ )\end{matrix} ] . \qquad ( 4 )$$

Assuming that the center of rotation does not move relative to sensor 105, r(t) is the same as a rotated version of r(0), i.e.,
r(t)=Rs_{θ(t)}r(0). (5)

In an embodiment, the curves sₓ(t), s_{y}(t), and s_{θ}(t) may be generated by spline interpolation from the measured data obtained from motion sensor 105. A family of curves may be obtained based upon measurement tolerances or sensitivity of motion sensor 105. As will be explained in more detail below, during optimization, this family of curves may be searched using gradient and line-based searches to improve the deblurring process.

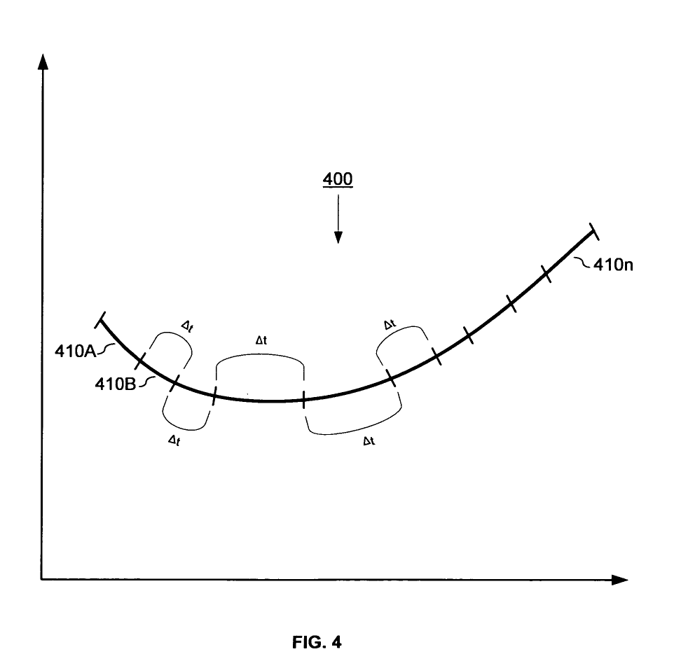

FIG. 4 depicts an exemplary motion path 400 in the image plane constructed from parameters received from motion sensor 105. Motion path 400 comprises an array of segment elements 410A-n. In an embodiment, each of the segment elements 410 represents an equal time interval, Δt. Accordingly, some elements 410 may transverse a greater distance than other elements depending upon the velocity at the given time interval. An image is created when the light energy is integrated by pixel elements of image sensor array 102 over a time interval. Assuming a linear response of the sensor elements with respect to exposure time, the intensity of each pixel in the path will be proportional to the time spent by the point within the pixel.

Returning to FIG. 3, the motion path constructed from the path of a point on the image plane that moves in accordance with the motion parameters specified in the tuple (2) is convolved 320 with the optical point spread function of imaging device 100. In an embodiment, the optical point spread function may be obtained by registering and averaging several images of a point source, such as an illuminated pin hole. One skilled in the art will appreciate that various techniques exist to conduct such measurement of modeling and are within the scope of the present invention. The convolved result, the combined motion and optical point spread function, is normalized 330 so that each element of the array is greater than or equal to 0 and the sum of all the elements in the array is 1.

Thus, the joint motion and optical point spread function, h(x,y), is given by,

$$\begin{matrix}h ( x , y ) ∝ o ( x , y ) * {\int \int \int }_{t ∈ [ 0 , T ] , y , x} δ ( x - x ( t ) ) ⅆ x δ ( y - y ( t ) ) ⅆ y ⅆ t , \\ and , & ( 6 ) \\ {\int \int }_{x , y} h ( x , y ) ⅆ x ⅆ y = 1 & ( 7 )\end{matrix}$$

where, o(x,y) is the optical point spread function, T is the exposure time, x(t),y(t) trace the image feature path, and δ(.) is the Dirac delta distribution.

It should be noted that pure translation motion results in the same h(x,y) for all locations, (x,y). However, rotation makes h(x,y) depend on (x,y). For the present development, it may be assumed that rotation is small, and over small image blocks (as compared to the radius of rotation), may be approximated by a translation along the direction of rotation.

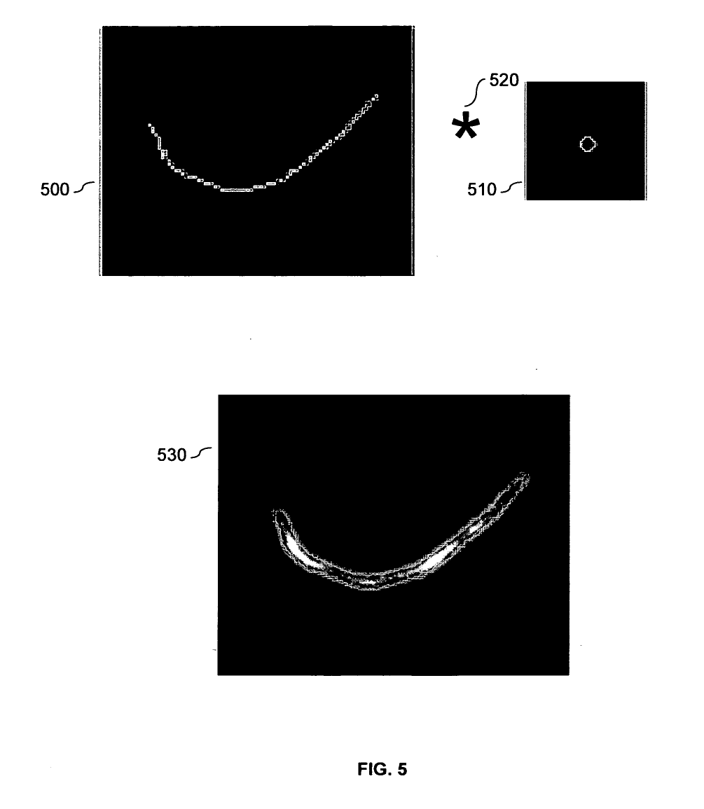

FIG. 5 graphically illustrates the generation of a combined or joint motion and optical point spread function. The motion path point spread function 500 is derived by constructing 310 the path of a point on the image plane that moves in accordance with the motion parameters obtained from motion sensor 105. The optical point spread function 510 is related to the performance of imaging device 100 and may be obtained from the previous measurements. The motion path point spread function 500 is convolved 520 with the optical point spread function 510 to obtain a combined point spread function 530.

3. Image Blocks

To reduce processing and allow for the simplification of treating rotation as small translations that are constant within small regions but vary across regions, two or more image blocks may be defined over the captured image. To select image blocks, the dimensions of a region of support are established. In an embodiment, the region of support is the tightest rectangle that bounds the combined point spread function, h(x,y), (i.e., {(x,y):h(x,y)>0}). That is, the region of support is large enough to contain the point spread function describing both the motion and optical blurs. In an embodiment, if the tightest bounding rectangle of the region of support for the combined point spread function, h(x,y), has dimensions W×H, image blocks may be defined as rectangular blocks with dimensions (2J+1)W×(2K+1)H, where J and K are natural numbers. In an embodiment, J and K may be 5 or greater. The central W×H rectangle within such a defined image block is referred to as the region of support for the image block.

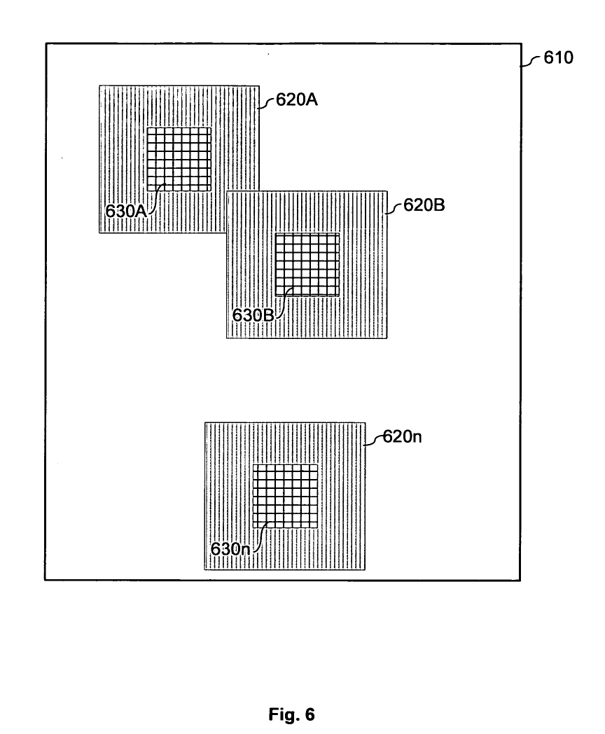

Exemplary image blocks, together with their respective regions of support, are depicted in FIG. 6. A number of image blocks 620A-620n may be identified within the capture image 610. In an embodiment, image blocks are chosen to contain image regions with high contrast and image variation. The use of blocks internal to the blurred image circumvents some of the boundary problems associated with estimating the point spread function from the entire image. Each of the image blocks 620A-620n possess a corresponding region of support 630A-630n, which is large enough to contain the combined point spread function. In an embodiment, image blocks may overlap as long as the corresponding regions of support do not overlap. For example, image block 620A and 620B overlap but their corresponding regions of support 630A and 630B do not overlap.

4. Parametric Semi-Blind Deconvolution

This section sets forth additional details related to how the captured image, g(x,y), is deconvolved using a modified blind, or “semi-blind,” deconvolution approach, wherein the point spread function is constrained to be among a family of functions that are consistent with the measured parameters.

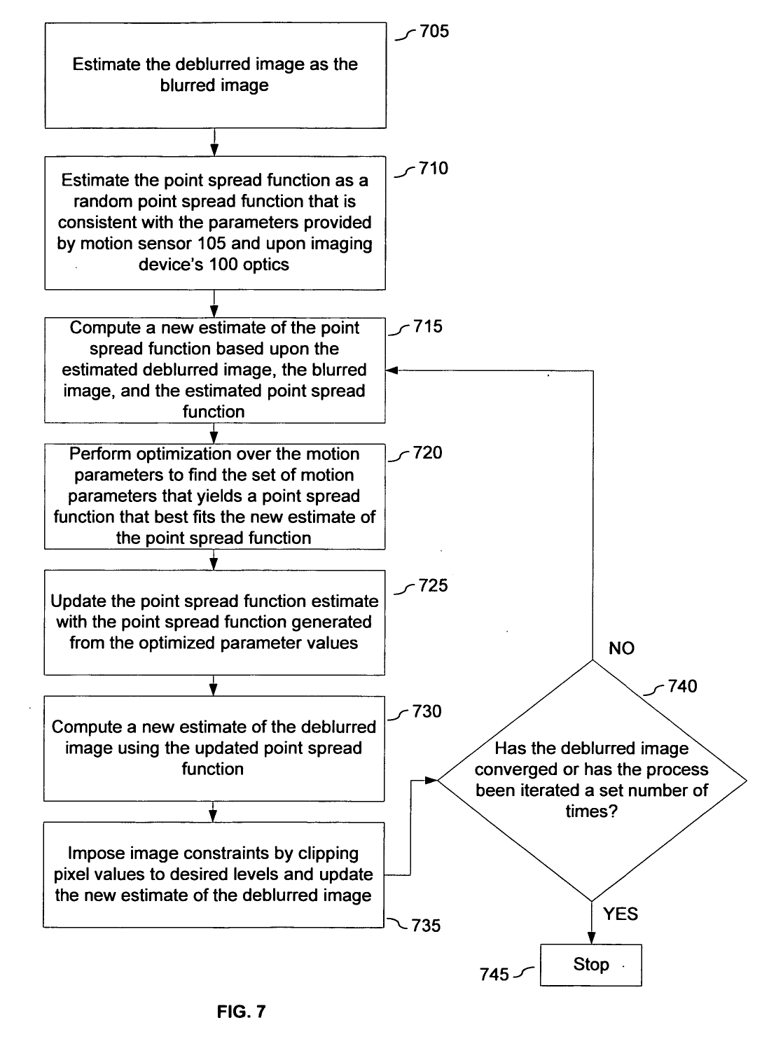

FIG. 7 illustrations an embodiment of an iterative blind deconvolution algorithm that has been modified using a parameterized point spread function model to deconvolve the image or an image block. An estimate of the deblurred image, denoted \hat{f}(x,y), is initialized 705 with the blurred image g(x,y). It should be noted that \hat{f}(x,y) and g(x,y) as used herein may refer to a portion of the whole image, i.e., an image block, of the entire image. An estimate of the combined point spread function, ĥ(x,y), is initialized 710 as a random point spread function consistent with the set of measurements. That is, the estimated combined point spread function, ĥ(x,y), is one that would fall within the family of motion paths that are possible given the measurement tolerance of the motion sensor 105. At each iteration, denoted by the subscript k, the deblurred image and point spread function estimates are update as follows.

A new estimate of the point spread function, \tilde{h}(x,y), is calculated 715 based upon the estimated deblurred image, the blurred image, and the estimated combined point spread function. The new estimate is computed by computing a Fast Fourier Transform of the estimated deblurred image:
\hat{F}ₖ(u,v)=FFT(\hat{f}ₖ(x,y)), (8)

where FFT( ) denotes the Fast Fourier Transform. Next, the transformed combined point spread function is computed:

$${\tilde{H}}_{k} ( u , v ) = \frac{G ( u , v ) {\hat{F}}_{k - 1}^{*} ( u , v )}{{\vert {\hat{F}}_{k - 1} ( u , v ) \vert}^{2} + β / {\vert {\tilde{H}}_{k - 1} ( u , v ) \vert}^{2}} , \qquad ( 9 )$$

where, G(u,v)=FFT(g(x,y)), β is real constant representing the level of noise, and a* denotes the complex conjugate of a. In an embodiment, the level of noise, β, may be determined by experimental evaluation of the quality of the result. Furthermore, the same β will typically work for a given sensor product. One skilled in the art will also recognize that there are other methods for relating β to the noise variance under specific noise models. It should be noted that no specific method of determining or estimating β is critical to the present invention.

The new estimate of the point spread function, \tilde{h}ₖ(x,y), is computed by taking the Inverse Fast Fourier Transform of the transformed point spread function, \tilde{H}ₖ(u,v):
\tilde{h}ₖ(x,y)=IFFT(\tilde{H}ₖ(u,v)), (10)

where IFFT( ) denotes the Inverse Fast Fourier Transform. An optimization is performed 720 over the motion parameters obtained from the sensor 105 to find the set of motion values or parameters that yields a combined point spread function that best fits \tilde{h}ₖ(x,y).

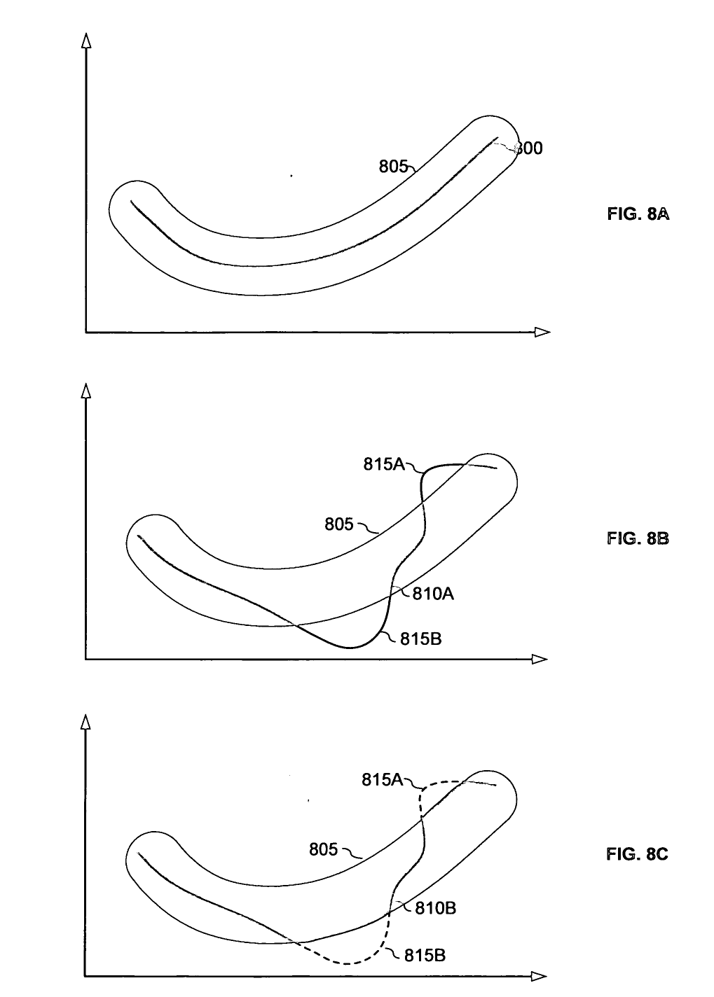

As noted previously, the measured parameters may possess some measurement tolerance or error. Accordingly, each of the parameters in (2) may be assumed to lie within a range of values determined by sensor properties, reliability of measurements, and prior information about the imaging device 100 components. In an embodiment, for any measured parameter p in the tuple (2), the true parameter value may lie in the range (p_{measured}−Δp, p_{measured}+ΔP). One skilled in the art will recognize that the measured parameter may not have a symmetrically disposed interval, but rather, may have non-symmetric interval values. FIG. 8A depicts a motion path 800. Because of tolerances, the actual motion path 800 may be any of a family of motion paths 805 that fall within the measurement tolerances or sensitivities. During the calculation of a new estimate of the combined point spread function, it is possible that the new estimate may generate a motion path 810A in which portion 815A, 815B fall outside the family of possible motion paths 805. Such a motion path 810A is not a good estimate of the actual motion path because, even when considering measurement error, it exceeds the measured parameters. In an embodiment, as depicted in FIG. 8C, the estimated motion path may be corrected by clipping the portions 815A, 815B to fall within the measurement range. In an embodiment, the clipped motion path 810B may be smoothed by a low-pass filter. The corrected motion path 810B provides a more realistic estimate of the motion path, which in turn, should help generate a better deblurred image.

In an embodiment, instead of clipping the motion path, interval constraints may be imposed by mapping the interval constraints to a smooth unconstrained variable. In an embodiment, the interval constraints may be mapped to smooth unconstrained variables using the following transformation:

$$p = {p}_{measured} - Δ p + \frac{2 Δ p}{1 + exp ( - γ {p}_{unconstrained} )} \qquad ( 10 )$$

where, p_{unconstrained} is an unconstrained real value, and γ is a scale factor. Mapping constrained parameters to unconstrained variables ensure that any random assignment of values to the unconstrained variables always results in a consistent assignment of the corresponding constrained parameters to be within the interval constraints.

The nominally specified parameters, αₓ, α_{y}, and r(0), may also be mapped to unconstrained variables based on prior information. In an embodiment, the prior information for αₓ and α_{y} includes the range of values for pixel width and pixel height, and the prior information for r(0) includes the range of possible distances for the center of rotation. In an embodiment, minimum and maximum values of the range are determined so that the probability of a random variable taking values outside this range is small. It may also be assumed that r(t) evolves according to Equation 5, above.

Returning the FIG. 7, the point spread function estimate, ĥₖ(x,y), is updated 725 with the point spread function generated from the optimized parameter values as described with respect to Equations (3)-(7), above.

Having obtained a new estimated point spread function, ĥₖ(x,y), a new deblurred image may be computed 730. The new deblurred image is obtained by first computing a Fast Fourier Transform of the new estimated point spread function, ĥₖ(x,y):
Ĥₖ(x,y)=FFT(ĥₖ(x,y)). (11)

Next, the transformed deblurred image is computed according to the following equation:

$${\tilde{F}}_{k} ( u , v ) = \frac{G ( u , v ) {\hat{H}}_{k - 1}^{*} ( u , v )}{{\vert {\hat{H}}_{k - 1} ( u , v ) \vert}^{2} + β / {\vert {\tilde{F}}_{k - 1} ( u , v ) \vert}^{2}} . \qquad ( 12 )$$

The new deblurred image, \tilde{f}(x,y), is computed by taking the Inverse Fast Fourier Transform of the transformed deblurred image:
\tilde{f}(x,y)=IFFT(\tilde{F}ₖ(u,v)). (13)

During the computations, it is possible that some of the image pixels may have pixel values outside an acceptable value range. For example, given an 8-bit pixel value, the pixel value may range between 0 and 255; however, the computation may yields values above or below that range. If the deblurring computations yield out-of-range values, deblurred image, \tilde{f}(x,y), should be constrained such that all out of range pixel values are corrected to be within the appropriate range. In an embodiment, the pixel values may be mapped to unconstrained variables in a manner similar to that described above. However, since an image array will likely contain a large number of pixels, such an embodiment may require excessive computation. In an alternate embodiment, the pixel values may be clipped to be within the appropriate range. In an embodiment, the pixel values may be set by application of projection onto convex sets. The deblurred image estimate, \hat{f}ₖ(x,y), is updated 735 to be the constrained pixel value version of the deblurred image estimate.

The process is iterated to converge on the deblurred image. In an embodiment, the deblurring algorithm is iterated until the deblurred image converges 745. In an embodiment, a counter, k, may be incremented at each pass and the process may be repeated 745 for fixed number of iterations.

5. Integrating Information Across Image Blocks

It should be noted that an additional benefit of employing two or more image blocks is that the information may be compared against each other to help deblur the captured image. In an embodiment, once the parameters of each block have converged or the deconvolution has been iterated a set number of times, the best parameters may be determined and broadcasted to all the blocks for reinitialization and further optimization iterations. The quality of the solution obtained at each broadcast iteration is recorded. The best parameter set obtained after the broadcast parameters have converged, or after a fixed number of broadcast cycles, may be used to deblur the entire image. At this stage, the entire image is partitioned into blocks and deblurring is performed with a fixed parameter set. That is, the best parameter set obtained after the broadcast parameters have converged, ĥₖ(x,y), is used for each block and need not be updated between iterations.

In an embodiment, the best parameters to be broadcast at the end of each block deconvolution cycle may be determined using a generalized cross-validation scheme. First, a validation error is computed for each image block. This validation error is defined as
E⁽ⁿ⁾=∥f⁽ⁿ⁾*h⁽ⁿ⁾−g⁽ⁿ⁾∥ (14)

where, the superscript n ∈{0, . . . , N−1} indexes the image blocks, \hat{f} and ĥ are the estimates for the deblurred image and point spread function of the block, and g⁽ⁿ⁾ is the blurred data belonging to the image block.

The best parameter set, which correlate to the lowest E⁽ⁿ⁾, among N−1 image blocks may then be used to deblur the remaining image block, and a validation error is computed for this image block. This process is repeated N times to compute a set of N validation errors. The parameter set with the lowest validation error is broadcast to all image blocks. The average validation error of all image blocks with this choice of parameter is recorded as a measure of the quality of the solution.

One skilled in the art will recognize that the present invention may be utilized in any number of devices, including but not limited to, web cameras, digital cameras, mobile phones with camera functions, personal data assistants (PDAs) with camera functions, and the like. It should also be noted that the present invention may also be implemented by a program of instructions that can be in the form of software, hardware, firmware, or a combination thereof. In the form of software, the program of instructions may be embodied on a computer readable medium that may be any suitable medium (e.g., device memory) for carrying such instructions including an electromagnetic carrier wave.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

I claim:

1. A method for deblurring a captured image taken by an imaging device comprising an imaging sensor array for capturing the image during an exposure time and at least one motion sensor, the method comprising the steps of:
[a] obtaining the captured image;
[b] obtaining a set of motion parameters from the motion sensor related to the motion of the imaging sensor array during the exposure time and wherein at least one of the motion parameters within the set of motion parameters possesses associated interval values such that a family of motion paths may be defined by the set of motion parameters and associated interval values;
[c] obtaining an estimated point spread function that comprises the convolution of an optical point spread function of the imaging device and a motion path selected from the family of motion paths defined by the set of motion parameters and associated interval values;
[d] selecting an estimated deblurred image;
[e] computing a new estimated point spread function based upon the captured image, the estimated deblurred image, and the estimated point spread function;
[f] performing an optimization over the set of motion parameters and associated interval values to find a set of optimized parameter values within the set of motion parameters and associated interval values that yield an optimized point spread function that best fits the new estimated point spread function; and
[g] using the optimized point spread function to compute a new estimated deblurred image.

2. The method claim 1 further comprising the step of:
[h] adjusting pixel values within the new estimated deblurred image to keep the pixel values within a specified value range.

3. The method claim 2 further comprising the steps of:
selecting the optimized point spread function as the estimated point spread function;
selecting the new estimated deblurred image as the estimated deblurred image; and
iterating steps [e] through [h].

4. The method of claim 3 wherein the steps are iterated a set number of times.

5. The method claim 1 wherein the step of [f] performing an optimization over the set of motion parameters and associated interval values to find a set of optimized parameter values within the set of motion parameters and associated interval values that yield an optimized point spread function that best fits the new estimated point spread function further comprises the step of:
[f′] mapping a motion parameter, from the set of motion parameters, and its associated interval values to an unconstrained variable to ensure that its optimized parameter value obtained from the optimization will produce a value that falls within the motion parameter's associated interval values.

6. The method claim 1 wherein the captured image is a portion of a larger captured image.

7. The method of claim 6 further comprising the steps of:
obtaining a plurality of sets of optimized parameter values from a plurality of captured images that are portions of the larger captured image;
obtaining a best set of optimized parameters from the plurality of sets of optimized parameters; and
deblurring the larger captured image using the best set of optimized parameters.

8. The method of claim 1 wherein the associated interval values represent a measurement sensitivity value.

9. A computer readable medium comprising a set of instructions for performing the method of claim 1.

10. An imaging device comprising:
an imaging sensor array for capturing an image during an exposure time;
a motion sensor that measures a set of motion parameters related to the imaging sensor array's motion during the exposure time;
a processor communicatively coupled to the imaging sensor array and adapted to perform the steps comprising:
[a] obtaining a captured image;
[b] obtaining a set of motion parameters from the motion sensor related to the motion of the imaging sensor array during the exposure time and wherein at least one of the motion parameters within the set of motion parameters possesses associated interval values such that a family of motion paths may be defined by the set of motion parameters and associated interval values;
[c] obtaining an estimated point spread function that comprises the convolution of an optical point spread function of the imaging device and a motion path selected from the family of motion paths defined by the set of motion parameters and associated interval values;
[d] obtaining an estimated deblurred image;
[e] computing a new estimated point spread function based upon the captured image, the estimated deblurred image, and the estimated point spread function;
[f] performing an optimization over the set of motion parameters and associated interval values to find a set of optimized parameter values within the set of motion parameters and associated interval values that yield an optimized point spread function that best fits the new estimated point spread function; and
[g] using the optimized point spread function to compute a new estimated deblurred image.

11. The imaging device of claim 10 wherein the processor is further adapted to perform the step comprising:
[h] adjusting pixel values within the new estimated deblurred image to keep the pixel values within a specified value range.

12. The imaging device of claim 11 wherein the processor is further adapted to perform the steps comprising:
selecting the optimized point spread function as the estimated point spread function;
selecting the new estimated deblurred image as the estimated deblurred image; and
iterating steps [e] through [h].

13. The imaging device of claim 12 wherein the steps are iterated a set number of times.

14. The imaging device of claim 10 wherein the step of [f] performing an optimization over the set of motion parameters and associated interval values to find a set of optimized parameter values within the set of motion parameters and associated interval values that yield an optimized point spread function that best fits the new estimated point spread function further comprises the step of:
[f′] mapping a motion parameter, from the set of motion parameters, and its associated interval values to an unconstrained variable to ensure that its optimized parameter value obtained from the optimization will produce a value that falls within the motion parameter's associated interval values.

15. The imaging device of claim 10 wherein the captured image is a portion of a larger captured image.

16. The imaging device of claim 15 wherein the processor is further adapted to perform the steps comprising:
obtaining a plurality of sets of optimized parameter values from a plurality of captured images that are portions of the larger captured image;
obtaining a best set of optimized parameters from the plurality of sets of optimized parameters; and
deblurring the larger captured image using the best set of optimized parameters.

17. A method for deblurring an image comprising:
[a] selecting a plurality of image blocks from a captured image, wherein the captured image was obtained from an imaging device with at least one motion sensor;
[b] estimating a point spread function within each of the plurality of image blocks, wherein each point spread function is consistent with a set of motion parameter values taken by the motion sensor during the capturing of the captured image;
[c] employing a deconvolution algorithm to deblur each of the plurality of image blocks wherein a modification to any of the point spread functions of the plurality of image blocks is consistent with the set of motion parameter values taken by the motion sensor during the capturing of the captured image;
[d] selecting a best point spread function from the point spread functions of the plurality of image blocks; and
[e] deblurring the captured image using the best point spread function.

18. The method of claim 17 wherein at least one of the values in the set of motion parameter values comprises a measurement sensitivity value.

19. The method of claim 17 wherein the step of [d] selecting a best point spread function from the point spread functions of the plurality of image blocks comprises using a cross-validation procedure.

20. A computer readable medium comprising a set of instructions for performing the method of claim 17.
